(19) United States
(12) Patent Application Publication
(10) Pub. No.: US 2013/0016132 A1
(43) Pub. Date: Jan. 17, 2013

(54) METHOD FOR EXAMINING LIQUID CRYSTAL DRIVING VOLTAGES IN LIQUID CRYSTAL DISPLAY DEVICE

(71) Applicant: YA-HUI CHIANG, Taichung City (TW)

(72) Inventor: YA-HUI CHIANG, Taichung City (TW)

(73) Assignee: Chunghwa Picture Tubes, LTD., Bade City (TW)

(21) Appl. No.: 13/244,299

(22) Filed: Sep. 24, 2011

(30) Foreign Application Priority Data
Jul. 15, 2011 (TW) 100125159

(51) Int. Cl. G09G 3/36; G09G 5/00

(52) U.S. Cl. 345/690; 345/89

(57) ABSTRACT

A method for examining liquid crystal driving voltages in a liquid crystal display device is provided. An image-sticking test frame is displayed on the liquid crystal display device. The image-sticking test frame includes at least one first pattern having a first gray level, at least one second pattern having a second gray level and at least one third pattern having a third gray level. The third gray level is between the first and second gray levels. The present invention uses the third gray level as a reference, so as to judge whether the liquid crystal driving voltage corresponding to the first gray level is accurate and whether the liquid crystal driving voltage corresponding to the second gray level is accurate.

### BACKGROUND OF THE INVENTION

1. Field of the Invention

The present invention generally relates to a liquid crystal display device, and more particularly to a method for examining liquid crystal driving voltages in a liquid crystal display device.

2. Description of Prior Art

When liquid crystals in a liquid crystal display device have been driven for a long period by a fixed voltage, an image-sticking phenomenon occurs. That is, when a static frame has been displayed for a long period, the static frame is still retained even a next frame is displayed. Accordingly, the liquid crystals should be driven by a voltage difference provided by an alternating voltage, so that polarities of the alternating voltage for driving the liquid crystals vary as frames change.

Currently, a method for examining whether voltages for driving the liquid crystals are symmetrical is executed by firstly displaying an image-sticking frame. Referring to FIG. 1, which is a schematic diagram showing a conventional image-sticking test frame 10, the image-sticking test frame 10 is a chessboard-like distribution composed by black patterns 10A and white patterns 10B. The black patterns 10A have a lowest light transmittance, which is defined as the lowest gray level. The liquid crystal driving voltage corresponding to the lowest gray level is referred to as a black voltage. The white patterns 10B have a highest light transmittance, which is defined as the highest gray level. The liquid crystal driving voltage corresponding to the highest gray level is referred to as a white voltage. After the image-sticking test frame 10 is displayed for a while, a judgment frame 20 as shown in FIG. 2 is displayed, that is, the black patterns 10A and the white patterns 10B of the image-sticking test frame 10 are adjusted to display an intermediate gray level. When the black patterns 10A and the white patterns 10B in FIG. 1 all become the intermediate gray level as shown in FIG. 2, it is indicative that the image-sticking phenomenon has not occurred. It is also indicative that the black voltage and the white voltage are symmetrical. When the black patterns 10A and the white patterns 10B remain as shown in FIG. 3, it is indicative that the image-sticking phenomenon has occurred, that is, the asymmetry might be caused by the black voltage, the white voltage, or both of them.

FIG. 4 is a schematic diagram showing another conventional image-sticking test frame 40. The image-sticking test frame 40 includes a white pattern 40B and a plurality of black patterns 40A displayed thereon. Regardless whether it is the image-sticking test frame 10 or the image-sticking test frame 40, a direct current bias voltage resulting from an alternating voltage asymmetry between the black voltage and the white voltage is generated, and thereby causing the above-mentioned image-sticking phenomenon to occur. The above-mentioned method can judge whether the black voltage and the white voltage are symmetrical. However, in the example shown in FIG. 1, the image-sticking frame 10 includes only the black patterns 10A and the white patterns 10B, and there are no patterns in an intermediate gray level. As a result, when the image-sticking phenomenon occurs, the only thing can be known is that the liquid crystals driving voltages (including the black and white voltages) are asymmetrical. It is not possible to know whether the asymmetry comes from the liquid crystal driving voltage corresponding to the black patterns 10A, or the liquid crystal driving voltage corresponding to the white patterns 10B, or both of them. Therefore, it is difficult to determine how to adjust the liquid crystal driving voltages.

Thus, there is a need for a solution to solve the above-mentioned problem that a diagnosis of the asymmetry source is difficult.

### SUMMARY OF THE INVENTION

An objective of the present invention is to provide a method for examining liquid crystal voltages in a liquid crystal display device so as to judge an asymmetry source of the liquid crystal driving voltages.

According to an aspect of the present invention, the method for examining the liquid crystal voltages in the liquid crystal display device comprises the following steps. An image-sticking test frame is displayed on the liquid crystal display device. The image-sticking test frame includes at least one first pattern, at least one second pattern, and at least one third pattern. The first pattern has a first gray level, the second pattern has a second gray level, and the third pattern has a third gray level between the first and second gray levels. A judgment frame is displayed on the liquid crystal display device after displaying the image-sticking test frame for a predetermined period. The judgment frame includes a pattern having the third gray level. It is judged whether the liquid crystal driving voltage corresponding to the first pattern is accurate by checking whether a region of the first pattern has the third gray level, while it is judged whether the liquid crystal driving voltage corresponding to the second pattern is accurate by checking whether a region of the second pattern has the third gray level.

The present invention uses the third gray level as a reference, so as to realized a judgment of whether the liquid crystal driving voltages corresponding to the first and second gray levels are accurate.

### BRIEF DESCRIPTION OF THE DRAWINGS

FIG. 1 is a schematic diagram showing a conventional image-sticking test frame;

FIG. 2 is a schematic diagram showing a judgment frame;

FIG. 3 is a schematic diagram showing the black and the white patterns in FIG. 2 are retained in the judgment frame;

FIG. 4 is a schematic diagram showing another conventional image-sticking test frame;

FIG. 5 is a flow chart according to a method for examining liquid crystal driving voltages in a liquid crystal display device;

FIG. 6 is a schematic diagram showing an image-sticking test frame according to the present invention;

FIG. 7 is a schematic diagram showing a judgment frame according to the present invention;

FIG. 8 is a schematic diagram showing the first and the second patterns in FIG. 6 are retained in the judgment frame in FIG. 7;

FIGS. 9-11 are schematic diagrams showing three different image-sticking test frames; and

FIG. 12 is a schematic diagram showing another image-sticking test frame.

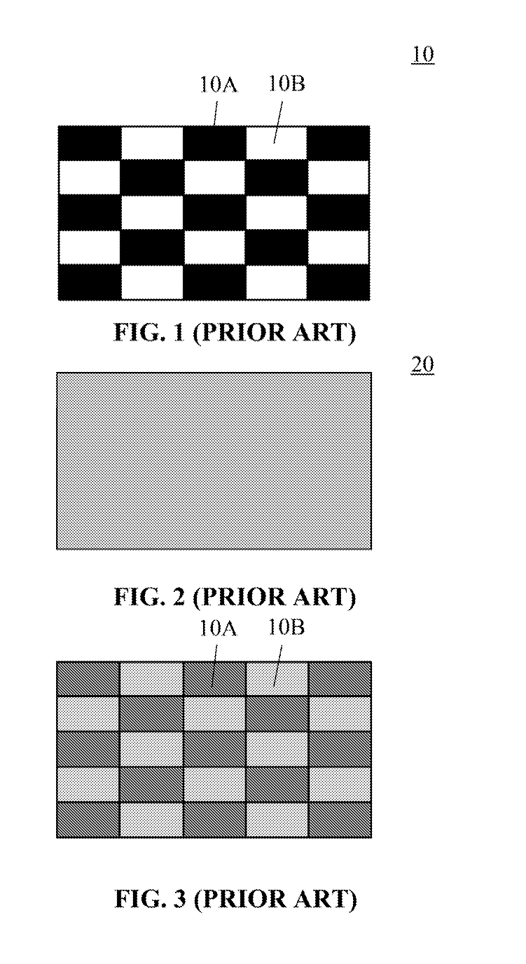

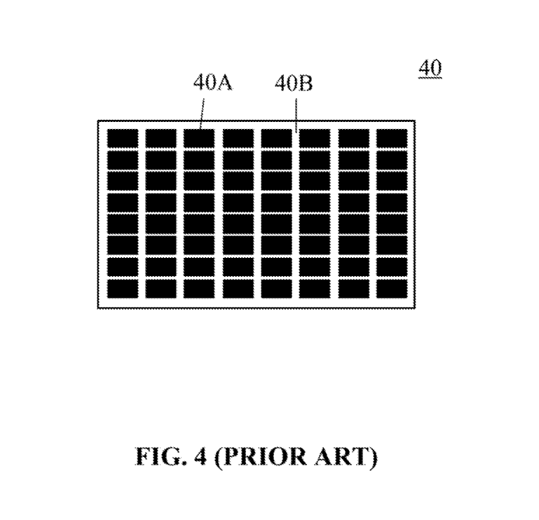

### DETAILED DESCRIPTION OF THE INVENTION

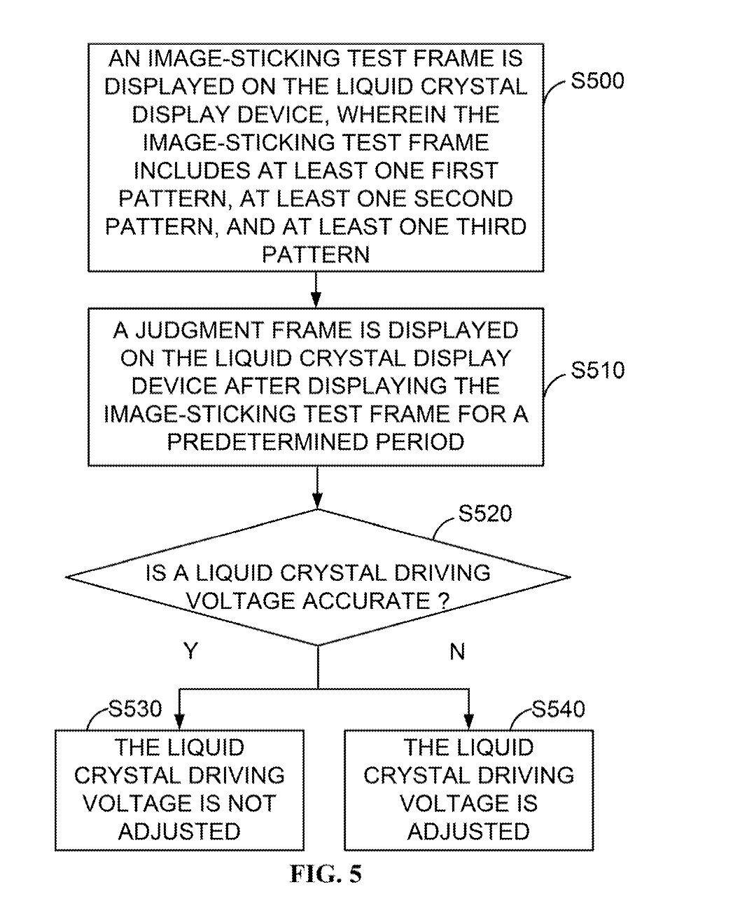

Please refer to FIG. 5, which shows a flow chart according to a method for examining liquid crystal driving voltages in a liquid crystal display device. Firstly, in step S500, an image-sticking test frame 60 which is shown in FIG. 6 is displayed on the liquid crystal display device. The image-sticking test frame 60 includes at least one first pattern 60A, at least one second pattern 60B, and at least one third pattern 60C. The first pattern 60A has a first gray level, and the second pattern 60B has a second gray level. In the present embodiment, the first gray level is a lowest gray level, and the second gray level is a highest gray level. That is, the first pattern 60A is a black pattern, and the second pattern 60B is a white pattern. In one preferred embodiment, the third pattern 60C is positioned in a periphery of the first pattern 60A and a periphery of the second pattern 60B. The “periphery” comprises an upper direction, a lower direction, a left direction, a right direction, an upper left direction, a lower left direction, an upper right direction, or a lower right direction.

In accordance with the present invention, the third pattern 60C is additionally added into the image-sticking test frame 60. The third pattern 60C has a third gray level between the first gray level and the second gray level. The liquid crystal driving voltage corresponding to the third gray level is adjusted to be a symmetrical alternating voltage before displaying the image-sticking test frame 60. Accordingly, the liquid crystal driving voltage corresponding to the third gray level can serve as a reference. In one preferred embodiment, the first gray level corresponds to a liquid crystal light transmittance that is less than 10%, the second gray level corresponds to a liquid crystal light transmittance that is greater than 90%, and the third gray level corresponds to a liquid crystal light transmittance that is ranged from 10% to 90%. Preferably, the third gray level can be selected to correspond to a liquid crystal light transmittance that is ranged from 20% to 30%, or from 50% to 60%. For example, when the liquid crystal display device is capable of displaying 256 gray levels, the third gray level may be 128th gray level (i.e. corresponding to a light transmittance that is substantially 22%), or 192nd gray level (i.e. corresponding to a light transmittance that is substantially 55%).

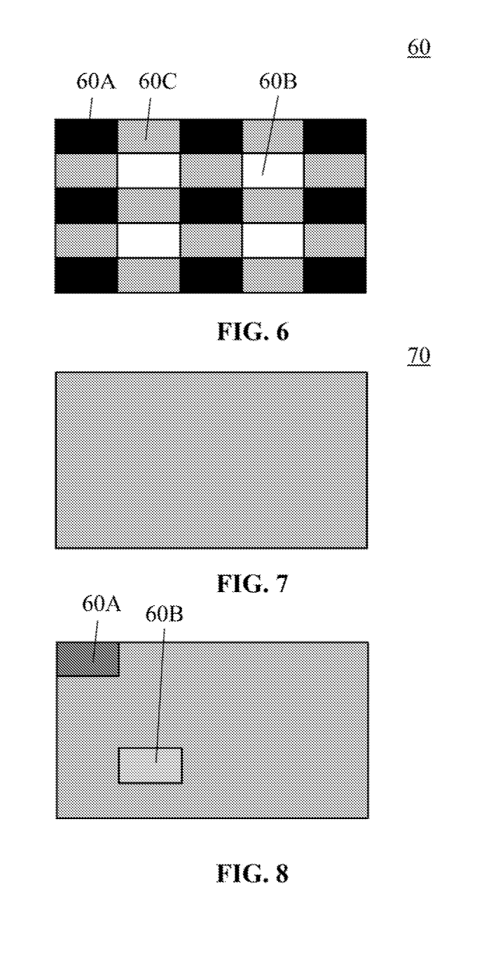

Then, in step S510, a judgment frame 70 which is shown in FIG. 7 is displayed on the liquid crystal display device after displaying the image-sticking test frame 60 for a predetermined period. The judgment frame 70 has the third gray level, that is, the first pattern 60A, the second pattern 60B, and the third pattern 60C are adjusted to display the third gray level.

As mentioned above, since the liquid crystal driving voltage corresponding to the third gray level is adjusted to be a symmetrical alternating voltage before displaying the image-sticking test frame 60, the third gray level which is displayed in a region of the third pattern 60C is accurate. Thus, the region of the third pattern 60C can be used as a reference in the following judgment steps.

In step S520, it is judged whether the liquid crystal driving voltage corresponding to the first pattern 60A is accurate by checking whether a region of the first pattern 60A has the third gray level, while it is judged whether the liquid crystal driving voltage corresponding to the second pattern 60B is accurate by checking whether a region of the second pattern 60B has the third gray level. When the displaying result after displaying the judgment frame 70 is as shown in FIG. 8, the image-sticking phenomenon occurs in the region of the first pattern 60A (i.e. the first pattern 60A is retained). Accordingly, the liquid crystal driving voltage corresponding to the first gray level can be judged to be not accurate. When the image-sticking phenomenon occurs in the region of the second pattern 60B (i.e. the second pattern 60B is retained), the liquid crystal driving voltage corresponding to the second gray level can be judged to be not accurate. In the present embodiment, the first pattern 60A is a black pattern, and it is indicative that the liquid crystal driving voltage corresponding to the black pattern (i.e. a black voltage) is not accurate. The second pattern 60B is a white pattern, and it is indicative that the liquid crystal driving voltage corresponding to the white pattern (i.e. a white voltage) is not accurate.

When both judgments of the liquid crystal driving voltages corresponding to the first and second gray levels are accurate, the liquid crystal driving voltages are not required to be adjusted in step S530. When at least one judgment of the liquid crystal driving voltages corresponding to the first and second gray levels is not accurate, the liquid crystal driving voltage which is judged as not accurate is required to be adjusted in step S540. The above-mentioned steps S500-S540 are repeated until the liquid crystal driving voltages are accurate and symmetrical.

It is noted that the image-sticking phenomenon occurs with respect to both the first pattern 60A and the second pattern 60B in the embodiment of FIG. 8. In another embodiment, the image-sticking phenomenon may occur with respect to only one of the first pattern 60A and the second pattern 60B, and thus only the liquid crystal driving voltage which corresponds to the one of the first pattern 60A and the second pattern 60B is required to be adjusted.

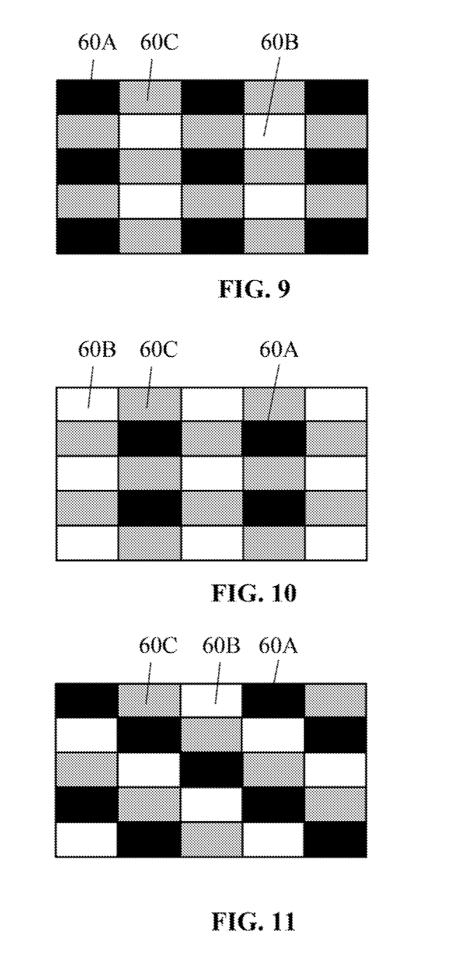

FIGS. 9-11 are schematic diagrams showing three different image-sticking test frames. However, the third pattern 60C is additionally added as a reference, so that a diagnosis of the asymmetry source of the liquid crystal driving voltages can be judged regardless of the arrangements of the first frames 60A and the second frames 60B.

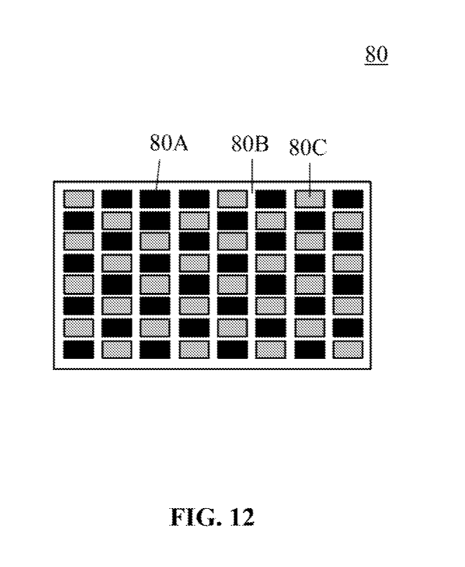

FIG. 12 is a schematic diagram showing another image-sticking test frame. Different from the image-sticking test frames in FIGS. 9-11, the image-sticking test frame 80 in FIG. 12 includes at least one first pattern 80A, a second pattern 80B, and at least one third pattern 80C which serves as a reference. The first pattern 80A is within the second pattern 80B which occupies a total area of the image-sticking test frame 80.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for examining liquid crystal voltages in a liquid crystal display device, the method comprising:
displaying an image-sticking test frame on the liquid crystal display device, the image-sticking test frame including at least one first pattern, at least one second pattern, and at least one third pattern, the first pattern having a first gray level, the second pattern having a second gray level, the third pattern having a third gray level, which is between the first and second gray levels;
displaying a judgment frame on the liquid crystal display device after displaying the image-sticking test frame for a predetermined period, the judgment frame including a pattern having the third gray level; and
judging whether the liquid crystal driving voltages corresponding to the first and second patterns are accurate by checking whether regions of the first and second patterns have the third gray level.

2. The method for examining the liquid crystal voltages in the liquid crystal display device as claimed in claim 1, wherein the first gray level is a lowest gray level, and the second gray level is a highest gray level.

3. The method for examining the liquid crystal voltages in the liquid crystal display device as claimed in claim 1, wherein the first gray level corresponds to a liquid crystal light transmittance that is less than 10%, and the second gray level corresponds to a liquid crystal light transmittance that is greater than 90%.

4. The method for examining the liquid crystal voltages in the liquid crystal display device as claimed in claim 1, wherein the third gray level corresponds to a liquid crystal light transmittance that is ranged from 10% to 90%.

5. The method for examining the liquid crystal voltages in the liquid crystal display device as claimed in claim 4, wherein the third gray level corresponds to a liquid crystal light transmittance that is ranged from 20% to 30%.

6. The method for examining the liquid crystal voltages in the liquid crystal display device as claimed in claim 5, wherein the third gray level corresponds to a liquid crystal light transmittance that is substantially 22%.

7. The method for examining the liquid crystal voltages in the liquid crystal display device as claimed in claim 4, wherein the third gray level corresponds to a liquid crystal light transmittance that is ranged from 50% to 60%.

8. The method for examining the liquid crystal voltages in the liquid crystal display device as claimed in claim 7, wherein the third gray level corresponds to a liquid crystal light transmittance that is substantially 55%.

9. The method for examining the liquid crystal voltages in the liquid crystal display device as claimed in claim 1, wherein the liquid crystal driving voltage corresponding to the third gray level is adjusted to be a symmetrical alternating voltage before displaying the image-sticking test frame.
